(19) United States
(12) Patent Application Publication
(10) Pub. No.: US 2004/0210564 A1
(43) Pub. Date: Oct. 21, 2004

(54) Indexing method and system for relational databases

(76) Inventor: Kenneth Oksanen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/480,273

(22) PCT Filed: Jun. 26, 2001
(86) PCT No.: PCT/EP01/07257

(51) Int. Cl. G06F 7/00

(52) U.S. Cl. 707/3

(57) ABSTRACT

The present invention relates to an indexing method and system for relational da-tabases, wherein a foreign key reference is routed by providing in a first table a reference to a second table referring to said first table. Thus, foreign key refer-ences to second tables are traversed via the index of the first table, such that a referential integrity can be implemented more easily and memory space can be saved. Furthermore, a key information is proposed to be removed from a row as it is inserted in a relation table, wherein the key information is obtained from an in-dex structure by a deduction operation. This leads to a further deduction of the required memory space.

### FIELD OF THE INVENTION

The present invention relates to an indexing method and system for a functional data structure in a relational database.

### BACKGROUND OF THE INVENTION

Traditional database systems comprise a large amount of mainly disk-resident data and a server which processes efficiently and reliably various Structured Query Language (SQL) transactions, such as money transfer orders and account balance queries.

Most database management systems have a layered structure. Assuming a three-layer division of a traditional database manager, the lowest layer performs disk input/output, provides media recovery, e.g. by mirroring or RAID, and crash recovery, e.g. with logs and periodic checkpointing. The second layer implements index structures, e.g. B-trees, on top of the primitives provided by the lower level. The highest level builds a data model abstraction on top of the index structures, interprets the query language, e.g. SQL, and communicates with the clients of the database.

An imperative implementation of tree-like data structures can usually be rather easily translated to its functional counter part. If a leaf node is modified, the path from the leaf to the route is copied yielding a new route. In N. Sarnac and R. E. Tarian, “Planar Point Location Using Persistent Search Trees”, Communications of the RCM, 29(7): 669-679, July 1986, this general technique is called path copying when implementing persistent data structures.

If the key of the tree is, or can conveniently be converted to a sequence of bits, tries as defined by E. Fredkin in “Trie memory”, Communications of the ACM, 3(9): 490-499, September 1960, or by G. H. Gonnet and R. Baeza-Yates in “Handbook of Algorithms and Data Structures”, Addison-Wesley, New York, 2nd edition, 1991 are usually unefficient index structures. The trie may use a path compression to compress sequence of single-child nodes into one node and a width compression to remove nil pointers from tree nodes. The trie may be used to implement e.g. integer-keyed maps of the database structure. Some of the tries may be dedicated to specific kinds of keys.

As an example, analysis trees assume that the keys are telephone digit strings. Similar dedicated index structures may be implemented for string keys and IP (Internet Protocol) routing tables. Additionally, strings may be represented with tree-like structures, wherein the leafs of the tree contain a varying number of characters, typically from one to thirty-two. Internal nodes of the tree behave somewhat similarly to nodes in B-trees except the trees are actually relative character positions from the beginning of the subtree. The root of the tree contains an offset into the string and its length. These two fields allow the programmer to skip characters from the beginning and the end of the string without having to copy internal and leaf nodes of the tree, only the route node. Removing characters from the beginning and the end of strings takes constant time.

Tries may be used to implement maps with integer-keys. While these can be used as normal arrays, they are efficient also when keys are distributed sparsely. The lowermost bits are shifted away from the tagged words representing the integer keys. Otherwise, the trie may be implemented one level higher, wherein all leaf nodes are singleton nodes.

The corresponding SQL-based query language may handle key columns of type integer, string and telephony digit string. The natural implementation of a table is then a map from the key columns type to the rows type. Tables with two or more key columns which together form the primary key are implemented by nested maps. For example, given key columns types α and β, the table is implemented by a map of key type α to a value which is a map of type β to the rows type. All tables are stored in a single trie indexed by a unique table-specific integer obtained by interning the tables name. The search path for a row is a list of records which instructs how to find the row in the database given a list of key values. The search path for a row stored in a first table whose interned string id is for example 34 and whose keys are of type digit string and integer can be expressed as a list [Table.<index:=34>, DigitString, Int], where the first element tells the search procedure to find the value stored for the key “34” in a map from integers to tables, and the following elements tell the type of the maps and keys for searching the row. Assuming a second table whose interned string id is for example “36”, whose first key columns are foreign key references to the first table, and whose third key column is a string. If the rows of the second table were to store in a data structure entirely separated from the first table, its search path would be [Table.<index:=36>, DigitString, Int, String]. However, whenever a record from the first table is deleted, an explicit check and a possible deletion of the corresponding records in the second table is required, and whenever a new record is inserted to the second table, the presence of the corresponding record in the first table has to be checked. This causes unnecessary searching in addition to the redundant memory consumption of double instances for the maps for the two first keys.

Furthermore, in integer-keyed tries, each key value in the trie represents one field value. Thus, when the keys are long and densely populated, a considerable amount of memory is consumed by the key fields.

### SUMMARY OF THE INVENTION

It is therefore an object of the present invention to provide an indexing method and system for relational databases, by means of which memory space can be saved and processing efficiency improved.

This object is achieved by an indexing method for a functional data structure in a relational database, the method comprising the steps of:

using foreign key references for indexing between different tables of the functional data structure; and

routing a foreign key reference by providing in a first table a reference to a second table referring to the first table.

Furthermore, the above object is achieved by an indexing system for a functional data structure in a relational database, the system comprising:

managing means for maintaining the relational database structure based on transaction statements received from clients; and

compiling means for compiling the transaction statements;

wherein the compiling means is arranged to use foreign key references for indexing between different tables of the functional data structure and to route a foreign key reference by providing in a first table a reference to a second table referring to the first table.

Accordingly, indices to the second tables and the index to the first table are merged. This means that foreign key references to second tables are traversed via the index of the first table. In the first table row obtained, there are then references to the associated second table rows. Due to the merged indices, reference integrity can be implemented more easily. Thus, a deletion from the first table can cause a cascaded deletion from the second tables, if desired.

Furthermore, in garbage collection schemes, memory and computation power is saved, since two or more tables are allowed to share a part of their indexes.

The first table may be a table in which a given key is a primary key, and the second table may be a table in which the given key is a foreign key. In this case, a search path may be assigned to the second table in such a manner that a flag signifies that if there is no row stored for the given key in the first table, then an insertion to the second table will fail.

Preferably, the first and second tables are maps from a key columns type to a rows type. The first and second tables may be stored in a single trie indexed by a unique table-specific integer.

The functional data structure may be a relational database, wherein the primary key of the second table may comprise the foreign key to the first table, and the index structure for the foreign key may comprise references to both rows of the first table and index structures for the primary key of the second table. In this case, the index structures for the primary key of the second table may comprise a part of the primary key not comprised within the foreign key.

Furthermore, the indexing system may be an SQL server.

Additionally, the above object is achieved by an indexing method for a functional data structure in a relational database, the method comprising the steps of:

representing rows of a relation table of the functional data structure by keyed tries;

removing the key information from a row as it is inserted in the relation table; and

obtaining the key information from an index structure by a deduction operation.

Furthermore, the above object is achieved by an indexing system for a functional data structure in a relational database, the system comprising:

managing means for maintaining the relational database structure based on transaction statements received from clients, rows of a relation table of the functional data structure being represented by keyed tries;

wherein the managing means is arranged to remove a key information from a row as it is inserted in a relation table, and to obtain the key information from an index structure by a deduction operation.

Accordingly, key columns are omitted from the physical representation of the relation table. Thereby, memory consumption is deduced. Given an existing implementation of the index, a conceptual simplification can be achieved, since indexes are separated from data.

The key information may be re-inserted to the row during an access operation.

In particular, the key information may be deduced from the manner how the index structure is traversed to obtain the next row. The key information may be allocated consecutively for the relation table.

### BRIEF DESCRIPTION OF THE DRAWINGS

In the following, the present invention will be described in greater detail on the basis of a preferred embodiment with reference to the accompanying drawing figures, in which:

FIG. 1 shows a thread organization in an SQL-based server;

FIG. 2A shows a diagram indicating a search path splitting for foreign key references, according to the preferred embodiment;

FIG. 2B shows an explanatory index structure with merged indices; and

FIG. 3 shows a diagram indicating an insertion and accessing of a row, according to the preferred embodiment.

### DESCRIPTION OF THE PREFERRED EMBODIMENT

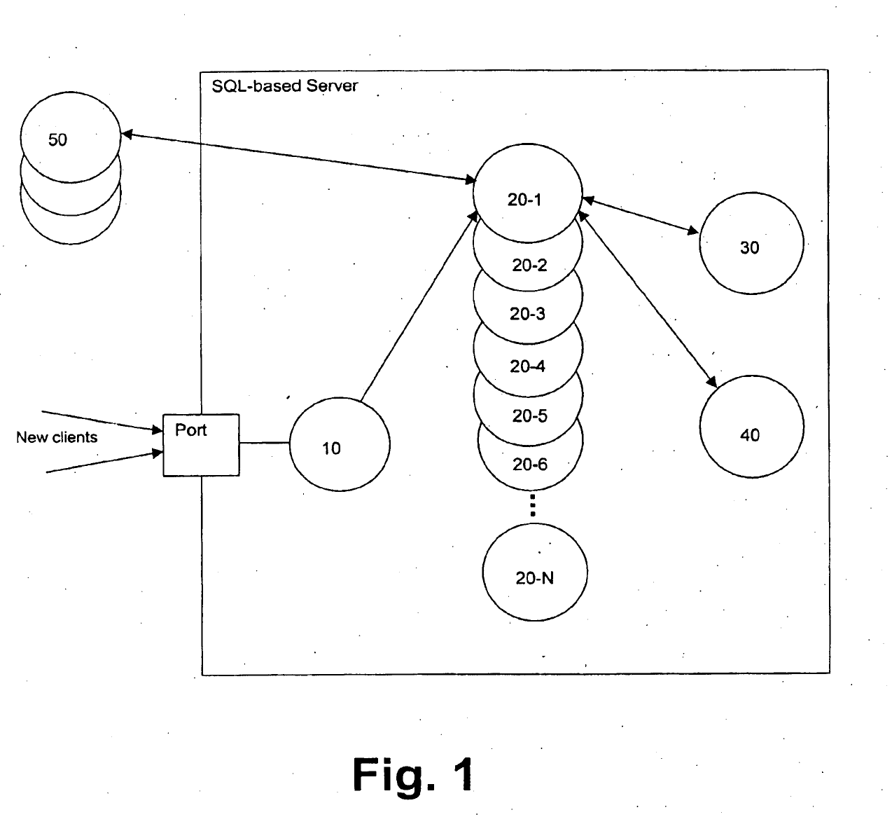

The preferred embodiment will now be described on the basis of a thread organization or architecture of an SQL-based server as shown in FIG. 1. An acceptor thread 10 is arranged to listen to the port for new connections from clients and spawns a client thread for each connection. The client or transaction threads 20-1 to 20-N communicate with the existing clients 50 using a language such as ODBC and represent the transactions to a manager thread 30 which in turn maintains the current state of the database and imposes a concurrency control among the transactions. The purpose of the concurrency control mechanism in relational database management systems is to isolate concurrent accesses to the database while allowing as much concurrent accesses as possible to different parts of the database.

Furthermore, a preparer thread 40 is provided, which receives new SQL statements and compiles, or prepares in ODBC palliants, the SQL statements into a structure, typically a forest of partially applied lambda functions, which can then be applied to perform the actions or transactions according to the SQL statement. The functionality of the preparer thread 40 may as well be incorporated in each of the transactions threads 20-1 to 20-N, but this would lead to the disadvantage that all of the possibly hundreds of connections would compile the SQL statement. By moving the compilation to the separate preparer thread 40, the compilation of each distinct SQL statement has to be done only once in the entire server.

Inefficiencies due to foreign key references, as initially indicated, can be removed by an indexing structure which deals with foreign key references between tables. In particular, foreign key references may be routed by a search path in such a manner that in a first table there is a reference to each second table referring to the first table. The first table is the table in which a given key is the primary key, whereas the second tables are the tables in which the given key is a foreign key.

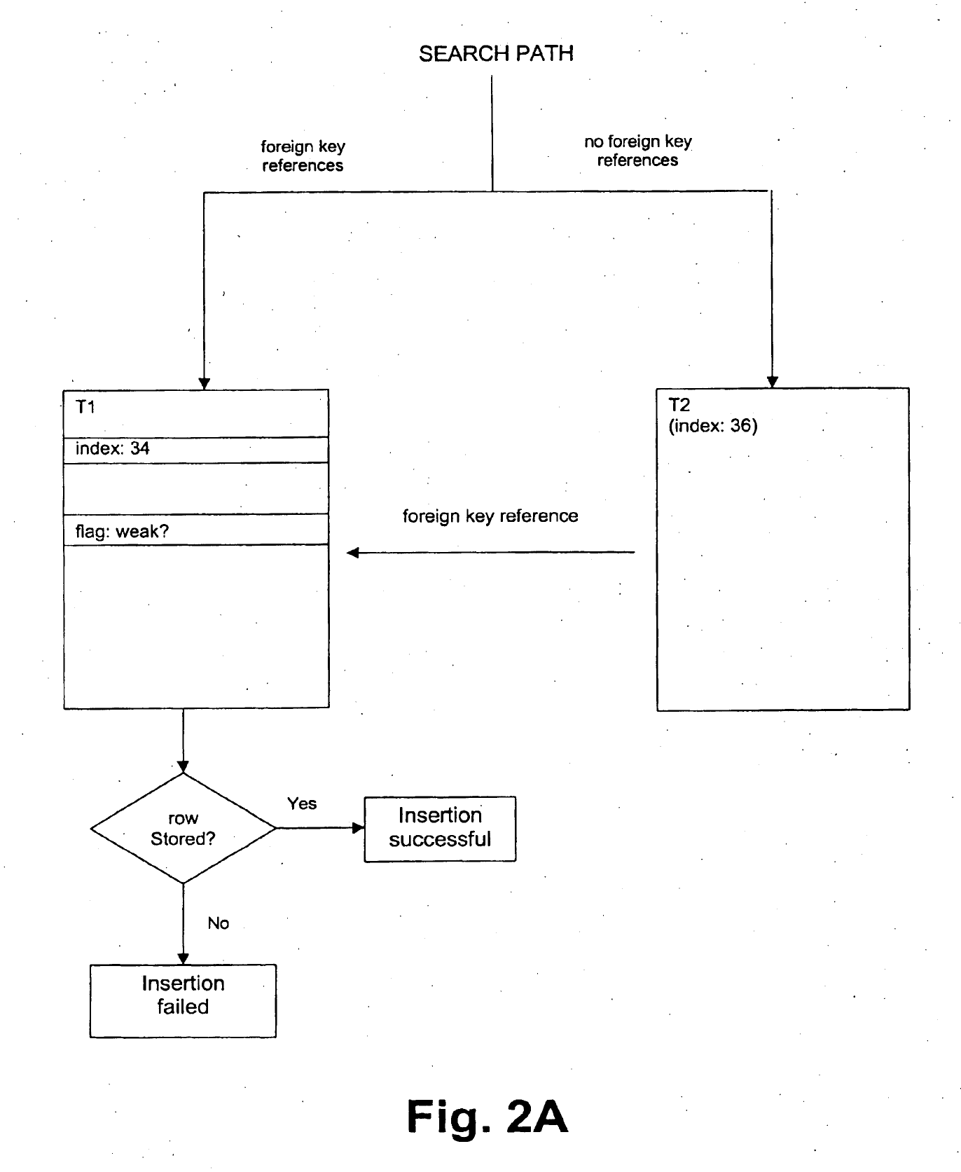

FIG. 2A shows an explanatory diagram, where a search path to a second table T2 having foreign key references to a first table T1 is split up or directed to the first table T1 for each foreign key reference. In particular the search path can be expressed as follows:

[Table.<index:=34>, DigitString, Int, Table.<weak?:=TRUE, index:=36>, String]

where a flag weak? indicates that if there is now row stored for the keys already searched for, then the insertion to the second table T2 will fail, thereby automatically ensuring a required foreign key integrity constrained for insertions.

As indicated in FIG. 2A, keys which do not relate to foreign key references are directly routed by the respective transaction thread to the second table T2 having an index value or interned string id “36”. On the other hand, keys relating to foreign key references are routed by the respective transaction thread to the referenced first table T1 having the interned string id “34”. When a row is stored for the keys which have been searched for, the insertion is initiated and thus successful. However, if the flag weak? is true and no row is stored or available, the insertion will fail and a corresponding indication or message is issued.

Since deletions from the first table T1 delete for the given keys all data, including possible subtables stored together with the row, foreign key integrity checking is ensured automatically also for deletions. In a typical relational database management system, the leg of garbage collection would require explicit deletion of all referring rows.

In an alternative case, when two tables which do not have any foreign key relation to each other are referenced by a third table having foreign key references to both tables, the third table cannot only stored under one of the two-related tables, since the foreign key integrity constrains would then be ignored. A solution to this problem would be to store the third table under one of the non-related tables, and leave some kind of information to the search path of the other table so that a deletion in the other table causes corresponding deletions in the third table. Furthermore, some kind of information should be left in the search path of the third table which ensures that insertions to it are only possible when corresponding rows are available in the other table. Thus, maintaining for the key integrity constraints will now require explicit checks when manipulating the third table and the other table of the non-related tables, whereas no such checks are necessary when manipulating the one table of the non-related tables. Furthermore, memory required for a separate map from the one table to subtables of the other table of the two-related tables can be saved.

FIG. 2A shows a case where index structures are merged for two tables. Thus, the search paths to both tables are the same. For the first table, the search path is used with a primary key and for the second table the search path is used with a secondary key. In particular, the indices to second tables and the index to the first table are merged. This means that foreign key references to the second tables are traversed via the index of the first table. In the first table row obtained there are then references to the associated second table rows. The example shown in FIG. 2A is related to an order management system where at least two tables are provided, one for customers and another for orders, i.e. orders placed by the customers. The customers are represented by customer numbers (e.g. integer values denoted cust#) and the orders per customer are represented by order numbers (e.g. integer values denoted order#). Each customer may be associated with a range from zero to a predetermined number of orders. Thus, each order is identified by a combination of cust# and order#.

According to the merged index structure shown in FIG. 2A, the integer value of cust# directly points to a row of a customer table and provides a foreign key reference to an order table by an associated or linked integer value of order# which points to a row of the order table. As an example, cust#=100 may indicate a company A and may provide a link to two orders numbers order#=1 and order#=2, wherein order#=1 relates to a total amount of 100 [symbol] and order#=2 relates to a total amount of 30 [symbol] . Furthermore, cust#=101 may indicate a company B and may provide a link to three orders order#=1 to order#=3, wherein order#=1 relates to a total amount of 200 [symbol] , order#=2 relates to a total amount of 300 [symbol] , and order#=3 relates to a total amount of 400 [symbol] . Additionally, cust#=103 may indicate a company C and may be associated with two orders order#=1 and order#=2, wherein order#=1 relates to a total amount of 500 [symbol] and order#=2 relates to a total amount of 100 [symbol] . This can be expressed as follows:

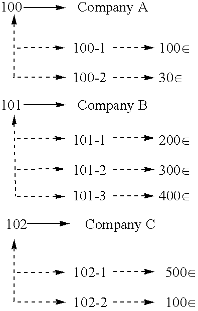

In the above relationships, solid arrows indicate primary key relationships to the customer table, while broken arrows indicate foreign key relationships. The tables of the database scheme thus can be expressed as customer(cust#, name) and order(cust#, order#, total). In addition thereto, other tables may be provided for items and/or products according to usual design options of relational databases. Hence, the primary key (e.g. 100-1 to 102-2) of the second table (i.e. order table) comprises the foreign key (e.g. 100 to 102) to the first table (i.e. customer table), and the index structure for the foreign key (e.g. 100 to 102) comprises references to both rows of the first table and index structures for the primary key of the second table. Furthermore, in the present example, the index structures for the primary key (X-1, X-2, . . . ) of the second table comprises a part of the primary key not comprised within the foreign key.

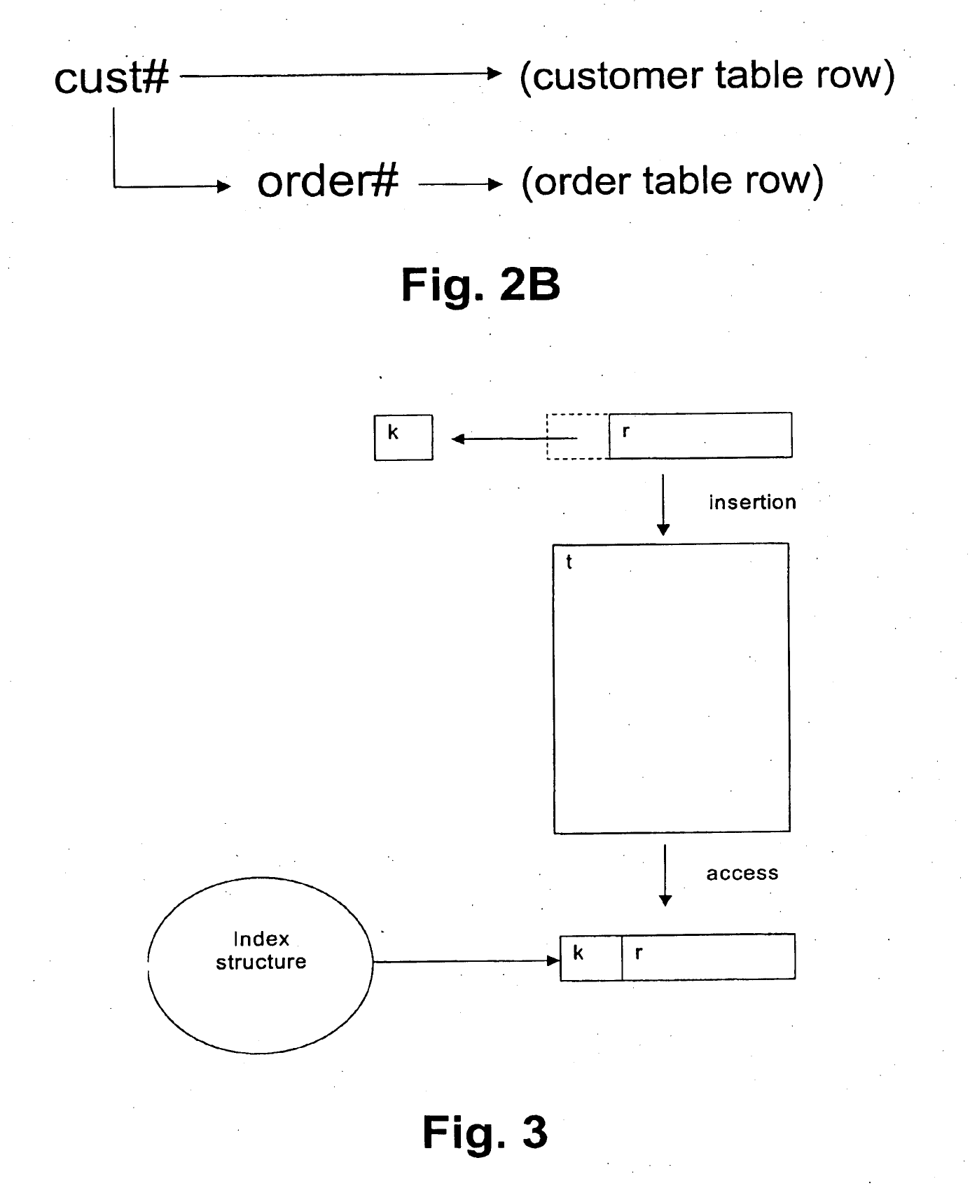

FIG. 3 shows a diagram indicating an insertion and accessing operation performed by the manager thread 30 for a row, which requires reduced memory in the relational database. In particular, rows are represented by integer-keyed tries. The key value in the trie represents one field value, and the keys are consecutively allocated for each table in order to reduce memory consumption. It fields are represented by an integer key, bit position and field width of e.g. 30 bits. Reading the value of the bit field is performed by a search operation for the given field in the trie representing the row and extracting the corresponding bits. If the bit field extends over to the next word, it may also have to be searched. Strings up to three correctors can be represented by a bit field where two bits denote the dynamic length of the string and depending on the static length of the string, either 8, 16 or 24 bits store the actual correctors. Correspondingly, strings up to 6 correctors can be stored in bit fields where 3 bits denote the dynamic length and the rest of the bits store the correctors. The bit fields are stored in a key region separated from other fields in order to ensure that other values are stored “aligned” to a single word value in the trie. If a sequence of zero bits covers the whole word, the corresponding key is removed from the trie, thereby saving considerable amounts of memory in cases where a majority of the bits are zero.

According to preferred embodiment, a significant memory optimization can be achieved in cases where the keys are long but the data fields are relatively few. Due to the fact that all index structures used in the SQL-based server contain sufficient information in the index structure itself to deduce the keys in the index without looking at the data, memory optimization can be achieved by removing the key fields from the rows as they are inserted in the tables. Correspondingly, the key fields can be reinserted to the rows as they are accessed in the indexes, as shown in FIG. 3.

Thus, the key columns are simply omitted from the physical representation of a relation table. The user still sees the key columns in a normal way, but the key column information is not stored in the database but obtained from index structures by a corresponding deduction information. For examples, when rows are fetched sequentially from tables, the key value of the next row is deduced from a manner in which the index structure is traversed to obtain the next row.

This optimization yields especially significant savings when the keys are long and densely populated. E.g., a map containing 33-digit telephone numbers randomly allocated among 27 million potential digit strings in a range of suffixes “0 000 000” to “1 999 999” consumes approximately 5.5 MB of memory, whereas one million separate 30-digit telephone numbers would consume 20 MB.

Thus, as indicated in FIG. 3, a key information k is separated from a row r during an insertion operation to a table t, and the key information k is deducted from the index structure and re-inserted into the row r during an accessing operation of the table t.

It is noted that the present invention is not restricted to the above described preferred embodiment, but can be modified in various ways within the scope of the attached claims.

1-16. (Cancelled)

17. An indexing method for a functional data structure in a relational database, said method comprising the steps of:
a) using foreign key references for indexing between a first table and a different second table of said functional data structure, said second table being a table in which a primary key of said first table is a foreign key; and
b) routing to said first table a key of said second table, if said key relates to a foreign key reference to said first table.

18. A method according to claim 17, further comprising the step of assigning a search path to said second table in such a manner that a flag signifies that if there is no row stored for said given key in said first table, then an insertion to said second table will fail.

19. A method according to claim 17, wherein said first and second tables are maps from a key columns type to a row's type.

20. A method according to claim 17, wherein said first and second tables are stored in a single trie indexed by a unique table-specific integer.

21. A method according to claim 17, wherein said functional data structure is a relational database, the primary key of said second table comprises said foreign key to said first table, and an index structure for said foreign key comprises references to both rows of said first table and index structures for said primary key of said second table.

22. A method according to claim 21, wherein said index structures for said primary key of said second table comprises a part of said primary key not comprised within said foreign key.

23. An indexing system for a functional data structure in a relational database, said system comprising:
a) managing means for maintaining said relational database structure based on transaction statements received from clients; and
b) compiling means for compiling said transaction statements;
c) wherein said compiling means is arranged to use foreign key references for indexing between a first table and a different second table of said functional data structure, said second table being a table in which a primary key of said first table is a foreign key; and to route to said first table a key of said second table, if said key relates to a foreign key reference to said first table.

24. A system according to claim 23, wherein said compiling means is arranged to assign a search path to said second table in such a manner that a flag signifies that if there is no row stored for a given key in said first table, then an insertion to said second table will fail.

25. A system according to claim 23, wherein said managing means is arranged to store said first and second tables in a single trie indexed by a unique table-specific integer.

26. A system according to claim 23, wherein said indexing system is an SQL server.

27. An indexing method for a functional data structure in a relational database, said method comprising the steps of:
a) representing rows of a relation table of said functional data structure by keyed tries;
b) removing a key information from a row as it is inserted in said relation table; and
c) obtaining said key information from an index structure by a deduction operation.

28. A method according to claim 27, wherein said key information is re-inserted to said row during an access operation.

29. A method according to claim 27, wherein said key information is deduced from the manner how said index structure is traversed to obtain the next row.

30. A method according to claim 27, wherein said key information is allocated consecutively for said relation table.

31. Indexing system for a functional data structure in a relational database, said system comprising:
a) managing means for maintaining said relational database structure based on transaction statements received from clients, rows of a relation table of said functional data structure being represented by keyed tries;
b) wherein said managing means is arranged to remove a key information from a row as it is inserted in a relation table, and to obtain said key information from an index structure by a deduction operation.
